(19) United States
(12) Patent Application Publication
(10) Pub. No.: US 2025/0310858 A1
(43) Pub. Date: Oct. 2, 2025

(54) INFORMATION INTERACTION METHOD AND DEVICE

(71) Applicant: VIVO MOBILE COMMUNICATION CO., LTD., Dongguan, Guangdong (CN)

(72) Inventors: Boubacar KIMBA DIT ADAMOU, Dongguan, Guangdong (CN); Xiaodong YANG, Dongguan, Guangdong (CN)

(21) Appl. No.: 19/237,042

(22) Filed: Jun. 13, 2025

Related U.S. Application Data
(63) Continuation of application No. PCT/CN2023/137900, filed on Dec. 11, 2023.

(30) Foreign Application Priority Data
Dec. 14, 2022 (CN) 202211610616.1

(51) Int. Cl. H04W 40/24; H04L 41/0806; H04W 84/04

(52) U.S. Cl. CPC H04W 40/246; H04L 41/0806; H04W 84/042

(57) ABSTRACT

An information interaction method and a device are provided, and pertain to the field of communications technologies. The method includes: A reader determines path information of a target device based on response information sent by a tag device, where the target device is configured to collect information about the tag device. The reader sends the information about the tag device to the target device based on the path information.

This application is a continuation of International Patent Application No. PCT/CN2023/137900, filed on Dec. 11, 2023, which claims priority to Chinese Patent Application No. 202211610616.1, filed with the China National Intellectual Property Administration on Dec. 14, 2022 and entitled “INFORMATION INTERACTION METHOD AND DEVICE”, both of which are incorporated herein by reference in their entireties.

### TECHNICAL FIELD

This application pertains to the field of communications technologies, and specifically relates to an information interaction method and a device.

### BACKGROUND

Radio Frequency Identification (RFID) is an automatic identification technology and a key technology for building the Internet of Things. An RFID system mainly includes a reader/writer (or referred to as a reader) and a transponder. A tag may usually serve as the transponder. Each tag has a unique electronic product code and is attached to an object to identify a target. The reader/writer is a device that reads and/or writes tag information.

The RFID technology is widely applied in various fields, especially in logistics, retail, clothing and other fields. In the era of interconnection of everything.

### SUMMARY

Embodiments of this application provide an information interaction method and a device.

According to a first aspect, an information interaction method is provided, and includes:

A reader determines path information of a target device based on response information sent by a tag device, where the target device is configured to collect information about the tag device.

The reader sends the information about the tag device to the target device based on the path information.

According to a second aspect, an information interaction method is provided, and includes:

A tag device receives a request message sent by a reader, where the request message is used to request the tag device to send response information.

The tag device sends the response information to the reader, where the response information is used to assist the reader in determining path information of a target device, and the target device is configured to collect information about the tag device.

According to a third aspect, an information interaction method is provided, and includes:

A target device receives information about a tag device sent by a reader, where the information about the tag device is sent based on path information of the target device, and the path information is determined based on response information sent by the tag device.

According to a fourth aspect, an information interaction apparatus is provided, and includes:
a processing module, configured to determine path information of a target device based on response information sent by a tag device, where the target device is configured to collect information about the tag device; and
a sending module, configured to send the information about the tag device to the target device based on the path information.

According to a fifth aspect, an information interaction apparatus is provided, and includes:
a receiving module, configured to receive a request message sent by a reader, where the request message is used to request a tag device to send response information; and
a sending module, configured to send the response information to the reader, where the response information is used to assist the reader in determining path information of a target device, and the target device is configured to collect information about the tag device.

According to a sixth aspect, an information interaction apparatus is provided, and includes:
a receiving module, configured to receive information about a tag device sent by a reader, where the information about the tag device is sent based on path information of the target device, and the path information is determined based on response information sent by the tag device.

According to a seventh aspect, a reader is provided. The reader includes a processor and a memory, the memory stores a program or an instruction that is executable on the processor, and when the program or the instruction is executed by the processor, the steps of the method according to the first aspect are implemented.

According to an eighth aspect, a reader is provided, and includes a processor and a communication interface. The processor is configured to determine path information of a target device based on response information sent by a tag device, where the target device is configured to collect information about the tag device. The communication interface is configured to send the information about the tag device to the target device based on the path information.

According to a ninth aspect, a tag device is provided. The tag device includes a processor and a memory, the memory stores a program or an instruction that is executable on the processor, and when the program or the instruction is executed by the processor, the steps of the method according to the second aspect are implemented.

According to a tenth aspect, a tag device is provided, and includes a processor and a communication interface. The communication interface is configured to receive a request message sent by a reader, where the request message is used to request the tag device to send response information; and send the response information to the reader, where the response information is used to assist the reader in determining path information of a target device, and the target device is configured to collect information about the tag device.

According to an eleventh aspect, a target device is provided. The target device includes a processor and a memory, the memory stores a program or an instruction that is executable on the processor, and the program or the instruction is executed by the processor to implement the steps of the method according to the third aspect.

According to a twelfth aspect, a target device is provided, and includes a processor and a communication interface. The communication interface receives information about a tag device sent by a reader, where the information about the tag device is sent based on path information of the target device, and the path information is determined based on response information sent by the tag device.

According to a thirteenth aspect, a communication system is provided, and includes a reader, a tag device, and a target device. The reader may be configured to perform the steps of the information interaction method according to the first aspect, the tag device may be configured to perform the steps of the information interaction method according to the second aspect, and the target device may be configured to perform the steps of the information interaction method according to the third aspect.

According to a fourteenth aspect, a readable storage medium is provided. The readable storage medium stores a program or an instruction, and the program or the instruction is executed by a processor to implement the steps of the method according to the first aspect, the steps of the method according to the second aspect, or the steps of the method according to the third aspect.

According to a fifteenth aspect, a chip is provided. The chip includes a processor and a communication interface. The communication interface is coupled to the processor. The processor is configured to run a program or an instruction, to implement the steps of the method according to the first aspect, the steps of the method according to the second aspect, or the steps of the method according to the third aspect.

According to a sixteenth aspect, a computer program/program product is provided. The computer program/program product is stored in a storage medium, and the computer program/program product is executed by at least one processor to implement the steps of the information interaction method according to the first aspect, or the steps of the information interaction method according to the second aspect or the third aspect.

In the embodiments of this application, the reader determines the path information of the target device based on the response information sent by the tag device. Further, the reader may send the information about the tag device to the target device based on the path information of the target device. The information about the tag device can also be reliably reported when the reader and the target device configured to collect the information about the tag device are not together.

### BRIEF DESCRIPTION OF DRAWINGS

FIG. 1 is a structural diagram of a wireless communication system to which embodiments of this application may be applied;

FIG. 2a is a first schematic diagram of an application scenario according to an embodiment of this application;

FIG. 2b is a second schematic diagram of an application scenario according to an embodiment of this application;

FIG. 3 is a first schematic flowchart of an information interaction method according to an embodiment of this application;

FIG. 4 is a schematic interaction flowchart of an information interaction method according to an embodiment of this application;

FIG. 5 is a second schematic flowchart of an information interaction method according to an embodiment of this application;

FIG. 6 is a third schematic flowchart of an information interaction method according to an embodiment of this application;

FIG. 7 is a first schematic diagram of a structure of an information interaction apparatus according to an embodiment of this application;

FIG. 8 is a second schematic diagram of a structure of an information interaction apparatus according to an embodiment of this application;

FIG. 9 is a third schematic diagram of a structure of an information interaction apparatus according to an embodiment of this application;

FIG. 10 is a schematic diagram of a structure of a communication device according to an embodiment of this application;

FIG. 11 is a schematic diagram of a structure of a terminal according to an embodiment of this application; and

FIG. 12 is a schematic diagram of a structure of a network side device according to an embodiment of this application.

### DESCRIPTION OF EMBODIMENTS

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill in the art based on the embodiments of this application shall fall within the protection scope of this application.

The terms “first”, “second”, and the like in this specification and claims of this application are used to distinguish between similar objects instead of describing a specific order or sequence. It should be understood that, the terms used in such a way are interchangeable in proper circumstances, so that the embodiments of this application can be implemented in an order other than the order illustrated or described herein. Objects classified by “first” and “second” are usually of a same type, and a quantity of objects is not limited. For example, there may be one or more first objects. In addition, in the description and the claims, “and/or” represents at least one of connected objects, and a character “/” generally represents an “or” relationship between associated objects. The term “indication” in the specification and claims of this application may be an explicit indication or an implicit indication. The explicit indication may be understood as that a sender explicitly notifies a sent indication of an operation that needs to be performed or a request result to a receiver. The implicit indication may be understood as that the receiver performs determining according to the indication sent by the sender, and determines, according to a determining result, the operation that needs to be performed or the request result.

It should be noted that technologies described in the embodiments of this application are not limited to a Long Term Evolution (LTE)/LTE-Advanced (LTE-A) system, and may be further applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-carrier Frequency Division Multiple Access (SC-FDMA), and other systems. The terms “system” and “network” in the embodiments of this application may be used interchangeably. The technologies described can be applied to both the systems and the radio technologies mentioned above as well as to other systems and radio technologies. A New Radio (NR) system is described in the following description for illustrative purposes, and the NR terminology is used in most of the following description, although these technologies can also be applied to applications other than the NR system application, such as the 6^{th} Generation (6G) communication system.

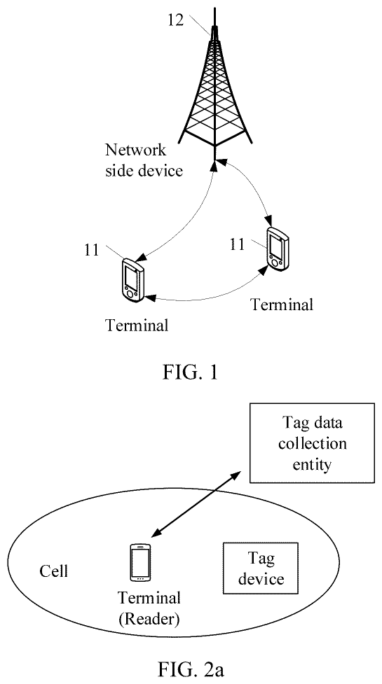

FIG. 1 is a block diagram of a wireless communication system to which embodiments of this application may be applied. The wireless communication system includes a terminal 11 and a network side device 12. The terminal 11 may be a terminal side device such as a mobile phone, a tablet personal computer, a laptop computer or a notebook computer, a Personal Digital Assistant (PDA), a palmtop computer, a netbook, an Ultra-Mobile Personal Computer (UMPC), a Mobile Internet Device (MID), an Augmented Reality (AR)/Virtual Reality (VR) device, a robot, a wearable device, Vehicle User Equipment (VUE), Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, a smart chain, and the like), a smart wrist strap, a smart dress, and the like. In addition to the terminal device, the terminal 11 may be a chip in the terminal, such as a modem chip or a System on Chip (SoC). It should be noted that a specific type of the terminal 11 is not limited in the embodiments of this application. The network side device 12 may include an access network device or a core network device. The access network device 12 may also be referred to as a radio access network device, a Radio Access Network (RAN), a radio access network function, or a radio access network unit. The access network device 12 may include a base station, a WLAN access point, a Wi-Fi node, or the like. The base station may be referred to as a NodeB, an evolved NodeB (eNB), an access point, a Base Transceiver Station (BTS), a radio base station, a radio transceiver, a Basic Service Set (BSS), an Extended Service Set (ESS), a home NodeB, a home evolved NodeB, a Transmitting Receiving Point (TRP), or another appropriate term in the field. As long as a same technical effect is achieved, the base station is not limited to a specified technical term. It should be noted that, in this application, only a base station in an NR system is used as an example, and a specific type of the base station is not limited. The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function Unit (PCRF), an Edge Application Service Discovery Function (EASDF), Unified Data Management (UDM), Unified Data Repository (UDR), a Home Subscriber Server (HSS), Centralized Network Configuration (CNC), a Network Repository Function (NRF), a Network Exposure Function (NEF), a Local NEF (L-NEF), a Binding Support Function (BSF), an Application Function (AF), or the like. It should be noted that, in the embodiments of this application, only a core network device in an NR system is used as an example for description, and a specific type of the core network device is not limited.

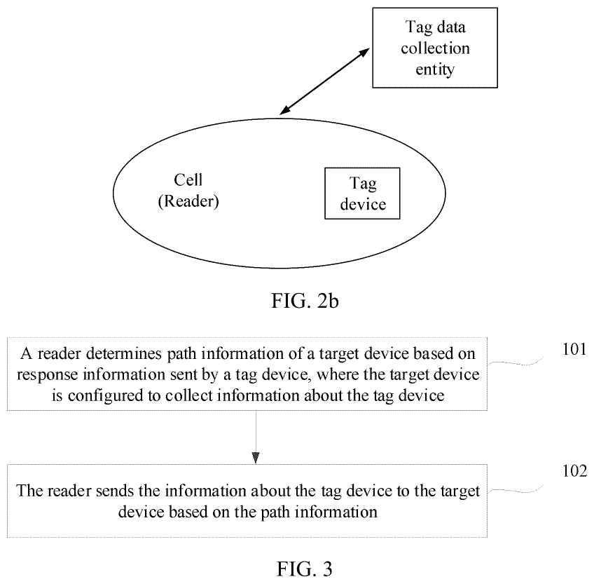

In the embodiments of this application, RFID is applied to a mobile cellular network, as shown in FIG. 2a and FIG. 2b. A reader may be a terminal or may be a network side device corresponding to a cell, such as a base station or another device. In some scenarios, the reader and a collection entity for information about a tag device may not be together, for example, are two different devices. For example, the reader is a terminal and the collection entity is a network side device or an application server. In this case, after the reader collects and reads the information about the tag device, the reader needs to know a specific entity to which collected data of the tag device is reported.

In the embodiments of this application, the reader reports the data of the tag device based on determined path information, such as an Internet Protocol (IP) address of a collection node.

With reference to the accompanying drawings, the following describes in detail an information interaction method provided in the embodiments of this application by using some embodiments and application scenarios thereof.

FIG. 3 is a first schematic flowchart of an information interaction method according to an embodiment of this application. As shown in FIG. 3, the method provided in this embodiment includes the following steps.

Step 101: A reader determines path information of a target device based on response information sent by a tag device, where the target device is configured to collect information about the tag device.

Specifically, the reader receives the response information sent by the tag device. The response information is sent by the tag device after the tag device receives a request message sent by the reader. The reader determines the path information of the target device based on the response information, that is, determines a specific device to which the collected information about the tag device needs to be reported. For example, the response information may carry the information about the tag device and/or information about the target device. For example, the reader may first determine an identifier of the target device based on the response information, and determine the path information of the target device based on the identifier of the target device. For example, the identifier includes an IP address of the target device.

Optionally, the reader obtains association information for the target device and the tag device in advance, may determine the path information of the target device based on the information about the tag device. For example, in a case that a tag device 1 is associated with a target device 1, or a tag device 1 is associated with a target device at a destination address 1, data of the tag device 1 needs to be reported to the target device 1 or the target device at the destination address 1. For example, a tag device whose type of tag data is a type 1 is associated with the target device 1, or a tag device in an area 1 is associated with the target device 1. Optionally, the tag device may obtain the reported information about the target device in advance and send the reported information about the target device to the reader when sending the response information to the reader.

For example, the tag device is various terminals in the Internet of Things, for example, may measure data such as temperature, humidity, battery level information, water usage, and an air pollution index.

Step 102: The reader sends the information about the tag device to the target device based on the path information.

Specifically, the reader sends the information about the tag device to the target device based on the path information of the target device, such as including an identifier ID of the tag device, tag data, a type of the tag data, and information about an area to which the tag device belongs.

For example, the tag data includes the temperature, the humidity, the battery level information, the water usage, and the air pollution index. For example, the type of the tag data includes a temperature data type, a humidity data type, a battery level data type, and a water usage data type.

For example, the information about the area to which the tag device belongs is information about a cell to which the tag device belongs, base station information, or a tracking area.

According to the method in this embodiment, the reader determines the path information of the target device based on the response information sent by the tag device. Further, the reader may send the information about the tag device to the target device based on the path information of the target device. The information about the tag device can also be reliably reported when the reader and the target device configured to collect the information about the tag device are not together. The tag device, the reader, and the target device configured to collect the information about the tag device can be deployed flexibly, so that a mobile cellular network can better support an RFID technology.

Optionally, the method further includes:

The reader receives configuration information sent by a network side device, where the configuration information includes at least one of the following: a correspondence between a type of tag data and an identifier of the target device, a correspondence between an identifier of the tag device and an identifier of the target device, or a correspondence between an area to which the tag device belongs and an identifier of the target device; and the identifier of the target device includes at least one of the following: a name of the target device, an ID of the target device, or an Internet Protocol IP address of the target device.

That a reader determines path information of a target device based on response information includes:

The reader determines the path information of the target device based on the configuration information and the response information.

Specifically, the response information may include the information about the tag device. The reader determines the identifier of the target device based on the configuration information sent by the network side device, such as the correspondence between the type of the tag data and the identifier of the target device, and the information about the tag device, and then obtains the path information of the target device.

For example, the network side device may configure the correspondence between the type of the tag data and the identifier of the target device for the reader. The reader may determine, according to the correspondence, the path information for reporting the tag data corresponding to the type of the tag data.

For example, the type 1 of the tag data corresponds to a server 1, an IP address IP 1, or a destination address dest 1, to indicate that the tag data whose type of the tag data is the type 1 is reported to the server 1, the IP address IP 1, or the destination address dest 1.

A type 2 of the tag data corresponds to a server 2, an IP 2, or a dest 2, to indicate that the tag data of the type 2 is reported to the server 2, the IP address IP 2, or the destination address dest 2.

When the reader sends a request message to the tag device, the tag device sends response data including tag data to the reader, and the reader reads the tag data, the reader determines a type of the tag data, may determine, according to the correspondence between the type of the tag data and the identifier of the target device configured to collect the tag data, the target device configured to collect the tag data, and report the tag data to the target device.

For example, for identification information of each tag device, such as the ID of the tag device, the network side device may configure the correspondence between the identifier of the tag device and the identifier of the target device for the reader. For example, all data of a tag device is reported to a destination corresponding to fixed path information.

For example, the tag device (tag) 1 corresponds to the server 1, the IP 1, or the dest 1, to indicate that all data of the tag 1 (such as a tag ID 1) is reported to a location of the server 1, the IP 1, or the destination address dest 1.

A tag 2 corresponds to the server 2, the IP 2, or the dest 2, to indicate that all data of the tag 2 (such as a tag ID 2) is reported to a location of the server 2, the IP 2, or the destination address dest 2.

When the reader sends a request message to the tag device, the tag device sends response data including tag data to the reader, and the reader reads the tag data, the reader determines the information about the tag device (such as the tag ID), may determine, according to the correspondence between the tag ID and the identifier of the target device configured to collect the tag data, the target device configured to collect the tag data, and report the tag data to the target device.

For example, for deployment area information of each tag, that is, the information about the area to which the tag device belongs, the network side device may configure the correspondence between the area to which the tag device belongs and the identifier of the target device for the reader. For example, data of all tag devices in an area is reported to a target device at a fixed location.

Optionally, the information about the area to which the tag belongs includes at least one of the following:
cell identification information (such as a Physical Cell Identifier (PCI), a Cell Global Identifier (CGI)), a cell list, base station information, a Tracking Area (TA), a Radio Access Network Notification Area (RAN Notification Area, RNA), or a Public Land Mobile Network (PLMN).

For example, an area 1 corresponds to the server 1, the IP 1, or the dest 1, to indicate that data of all tag devices in the area 1 is reported to the location of the server 1, the IP 1, or the destination address dest 1.

An area 2 corresponds to the server 2, the IP 2, or the dest 2, to indicate that data of all tag devices in the area 2 is reported to the location of the server 2, the IP 2, or the destination address dest 2.

When the reader sends a request message to the tag device, the tag device sends response data including tag data to the reader, and the reader reads the tag data, the reader determines the information about the area to which the tag device belongs, may determine, according to the correspondence between the information about the area to which the tag device belongs and the identifier of the target device configured to collect the tag data, the target device configured to collect the tag data, and report the tag data to the target device.

In the implementation, the network side device configures, for the reader, at least one of the following correspondences: the correspondence between the type of the tag data and the identifier of the target device, the correspondence between the identifier of the tag device and the identifier of the target device, or the correspondence between the area to which the tag device belongs and the identifier of the target device, to determine the path information of the target device. The information about the tag device can be reliably reported even when the reader and the target device configured to collect the information about the tag device are not together, and implementation complexity is relatively low.

Optionally, the path information of the target device may alternatively be directly determined based on the response information. For example, the tag device may directly report related information of the target device, such as an identifier ID, a name, and an IP address. The reader may determine the path information of the target device based on the related information of the target device reported by the tag device, and therefore report the information about the tag device to the target device.

The response information includes the identifier of the target device, or includes the identifier of the target device and first information, the first information includes at least one of the following: the identifier ID of the tag device or the tag data, and the identifier of the target device includes at least one of the following: the name of the target device, the ID of the target device, or the IP address of the target device.

Optionally, the identifier of the target device is configured by the network side device, or is preconfigured by the tag device.

Specifically, the tag device may be configured with the path information for reporting the tag data, which may be implemented in the following several manners:
1. The path information is configured by the network side device for the tag device.
2. The path information is preconfigured for the tag device before accessing a network, that is, the tag device comes with the path information.

Optionally, tag data of different tag devices may be configured with different path information.

When the reader sends the request message to the tag device, the tag device may generate the path information for reporting the tag data while responding to the reader.

Optionally, the identifier of the target device and the first information are carried in same signaling.

Optionally, the identifier of the target device and the first information are carried in different signaling.

Specifically, when the tag device sends the response information, the tag device may report the information about the target device, such as the identifier and the IP address of the target device. For example, the tag device may separately report the data of the tag device and the information about the target device. For example, different signaling is used for reporting. Alternatively, the data of the tag device and the information about the target device are centrally reported. For example, same signaling is used for reporting.

The reader determines the path information of the target device according to the response information sent by the tag device, and reports the information about the tag device to the target device based on the path information of the target device, for example, reports data measured by the tag device, the identifier of the tag device, and other information.

Further, the reader sends the first information to the target device based on the path information, that is, sends the collected information about the tag device, such as the identifier ID of the tag device and the tag data.

In the implementation, the reader may determine the path information of the target device based on the information about the target device carried in the response information of the tag device, and then send the information about the tag device to the target device based on the path information. The information about the tag device can also be reliably reported when the reader and the target device configured to collect the information about the tag device are not together, so that implementation complexity is relatively low.

In conclusion, the method in this embodiment of this application ensures, according to different deployment situations of target devices, that the reader can reliably report the related information to the target device configured to collect the information about the tag device, to bring more flexibility to deployment of the tag device and the target device, so that the information about the tag device is collected simply.

FIG. 5 is a second schematic flowchart of an information interaction method according to an embodiment of this application. As shown in FIG. 5, the method provided in this embodiment includes the following steps.

Step 201: A tag device receives a request message sent by a reader, where the request message is used to request the tag device to send response information.

Step 202: The tag device sends the response information to the reader, where the response information is used to assist the reader in determining path information of a target device, and the target device is configured to collect information about the tag device.

Optionally, the response information includes at least one of the following: an identifier ID of the tag device, tag data, a type of the tag data, or information about an area to which the tag device belongs.

Optionally, the information about the area to which the tag device belongs includes at least one of the following:
cell identification information, a cell list, base station information, a tracking area, a radio access network notification area RNA, or a public land mobile network PLMN.

Optionally, the response information includes an identifier of the target device, or includes an identifier of the target device and first information, the first information includes at least one of the following: an identifier ID of the tag device or tag data, and the identifier of the target device includes at least one of the following: a name of the target device, an ID of the target device, or an IP address of the target device.

Optionally, the method further includes:

The tag device receives the identifier of the target device sent by a network side device.

Optionally, the identifier of the target device is preconfigured by the tag device.

Optionally, the identifier of the target device and the first information are carried in different signaling.

Optionally, the identifier of the target device and the first information are carried in same signaling.

A specific implementation process and technical effects of the method in this embodiment are the same as those in the method embodiment on the reader side. For details, refer to the detailed descriptions in the method embodiment on the reader side. Details are not described herein again.

FIG. 6 is a third schematic flowchart of an information interaction method according to an embodiment of this application. As shown in FIG. 6, the method provided in this embodiment includes the following steps.

Step 301: A target device receives information about a tag device sent by a reader, where the information about the tag device is sent based on path information of the target device, and the path information is determined based on response information sent by the tag device.

The target device is configured to collect the information about the tag device.

Optionally, the response information includes at least one of the following: an identifier ID of the tag device, tag data, a type of the tag data, or information about an area to which the tag device belongs.

Optionally, the information about the area to which the tag device belongs includes at least one of the following:
cell identification information, a cell list, base station information, a tracking area, a radio access network notification area RNA, or a public land mobile network PLMN.

Optionally, the response information includes an identifier of the target device, or includes an identifier of the target device and first information, the first information includes at least one of the following: an identifier ID of the tag device or tag data, and the identifier of the target device includes at least one of the following: a name of the target device, an ID of the target device, or an IP address of the target device.

Optionally, that a target device receives information about a tag device sent by a reader includes:

The target device receives the first information sent by the reader.

A specific implementation process and technical effects of the method in this embodiment are the same as those in the method embodiment on the reader side. For details, refer to the detailed descriptions in the method embodiment on the reader side. Details are not described herein again.

The information interaction method provided in the embodiments of this application may be performed by an information interaction apparatus. In the embodiments of this application, an example in which the information interaction apparatus performs the information interaction method is used to describe the information interaction apparatus provided in the embodiments of this application.

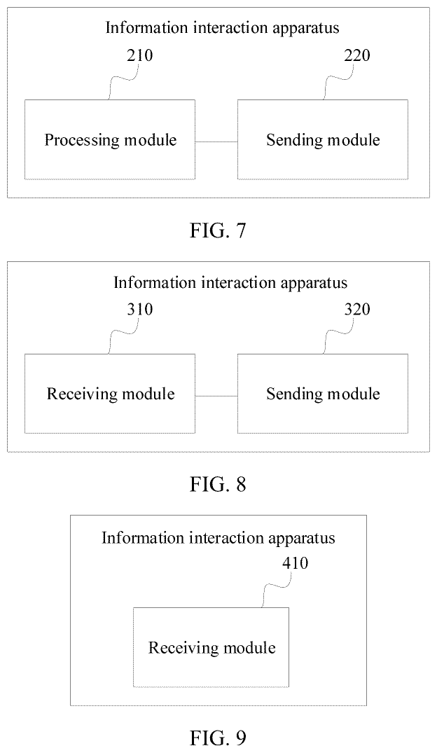

FIG. 7 is a first schematic diagram of a structure of an information interaction apparatus according to an embodiment of this application. As shown in FIG. 7, the information interaction apparatus provided in this embodiment includes:
a processing module 210, configured to determine path information of a target device based on response information sent by a tag device, where the target device is configured to collect information about the tag device; and
a sending module 220, configured to send the information about the tag device to the target device based on the path information.

Optionally, the apparatus further includes:
a receiving module, configured to receive configuration information sent by a network side device, where the configuration information includes at least one of the following: a correspondence between a type of tag data and an identifier of the target device, a correspondence between an identifier of the tag device and an identifier of the target device, or a correspondence between an area to which the tag device belongs and an identifier of the target device; and the identifier of the target device includes at least one of the following: a name of the target device, an ID of the target device, or an Internet Protocol IP address of the target device.

The processing module 210 is specifically configured to:
determine the path information of the target device based on the configuration information and the response information.

Optionally, the response information includes at least one of the following: an identifier ID of the tag device, tag data, a type of the tag data, or information about an area to which the tag device belongs.

Optionally, the information about the area to which the tag device belongs includes at least one of the following:
cell identification information, a cell list, base station information, a tracking area, a radio access network notification area RNA, or a public land mobile network PLMN.

Optionally, the response information includes an identifier of the target device, or includes an identifier of the target device and first information, the first information includes at least one of the following: an identifier ID of the tag device or tag data, and the identifier of the target device includes at least one of the following: a name of the target device, an ID of the target device, or an IP address of the target device.

Optionally, the identifier of the target device is configured by the network side device, or is preconfigured by the tag device.

Optionally, the identifier of the target device and the first information are carried in different signaling.

Optionally, the identifier of the target device and the first information are carried in same signaling.

Optionally, the sending module 220 is further configured to:
send a first request to the tag device, where the first request is used to request the tag device to send the response information.

The sending module 220 is specifically configured to:
send the first information to the target device based on the path information.

The apparatus in this embodiment may be configured to perform the method in any one of the method embodiments on the reader side. A specific implementation process and technical effects of the apparatus are the same as those in the method embodiment on the reader side. For details, refer to the detailed descriptions in the method embodiment on the reader side. Details are not described herein again.

FIG. 8 is a second schematic diagram of a structure of an information interaction apparatus according to an embodiment of this application. As shown in FIG. 8, the information interaction apparatus provided in this embodiment includes:
a receiving module 310, configured to receive a request message sent by a reader, where the request message is used to request a tag device to send response information; and
a sending module 320, configured to send the response information to the reader, where the response information is used to assist the reader in determining path information of a target device, and the target device is configured to collect information about the tag device.

Optionally, the response information includes at least one of the following: an identifier ID of the tag device, tag data, a type of the tag data, or information about an area to which the tag device belongs.

Optionally, the information about the area to which the tag device belongs includes at least one of the following:
cell identification information, a cell list, base station information, a tracking area, a radio access network notification area RNA, or a public land mobile network PLMN.

Optionally, the response information includes an identifier of the target device, or includes an identifier of the target device and first information, the first information includes at least one of the following: an identifier ID of the tag device or tag data, and the identifier of the target device includes at least one of the following: a name of the target device, an ID of the target device, or an IP address of the target device.

Optionally, the receiving module 310 is further configured to:
receive the identifier of the target device sent by a network side device.

Optionally, the identifier of the target device is preconfigured by the tag device.

Optionally, the identifier of the target device and the first information are carried in different signaling.

Optionally, the identifier of the target device and the first information are carried in same signaling.

The apparatus in this embodiment may be configured to perform the method in any one of the method embodiments on the tag device side. A specific implementation process and technical effects of the apparatus are the same as those in the method embodiment on the tag device side. For details, refer to the detailed descriptions in the method embodiment on the tag device side. Details are not described herein again.

FIG. 9 is a third schematic diagram of a structure of an information interaction apparatus according to an embodiment of this application. As shown in FIG. 9, the information interaction apparatus provided in this embodiment includes:
a receiving module 410, configured to receive information about a tag device sent by a reader, where the information about the tag device is sent based on path information of the target device, and the path information is determined based on response information sent by the tag device.

Optionally, the response information includes at least one of the following: an identifier ID of the tag device, tag data, a type of the tag data, or information about an area to which the tag device belongs.

Optionally, the information about the area to which the tag device belongs includes at least one of the following:
cell identification information, a cell list, base station information, a tracking area, a radio access network notification area RNA, or a public land mobile network PLMN.

Optionally, the response information includes an identifier of the target device, or includes an identifier of the target device and first information, the first information includes at least one of the following: an identifier ID of the tag device or tag data, and the identifier of the target device includes at least one of the following: a name of the target device, an ID of the target device, or an IP address of the target device.

Optionally, the receiving module 410 is specifically configured to:
receive the first information sent by the reader.

The apparatus in this embodiment may be configured to perform the method in any one of the method embodiments on the target device side. A specific implementation process and technical effects of the apparatus are the same as those in the method embodiment on the target device side. For details, refer to the detailed descriptions in the method embodiment on the target device side. Details are not described herein again.

The information interaction apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed types of the terminal 11, and the another device may be a server, a Network Attached Storage (NAS), or the like. This is not specifically limited in this embodiment of this application.

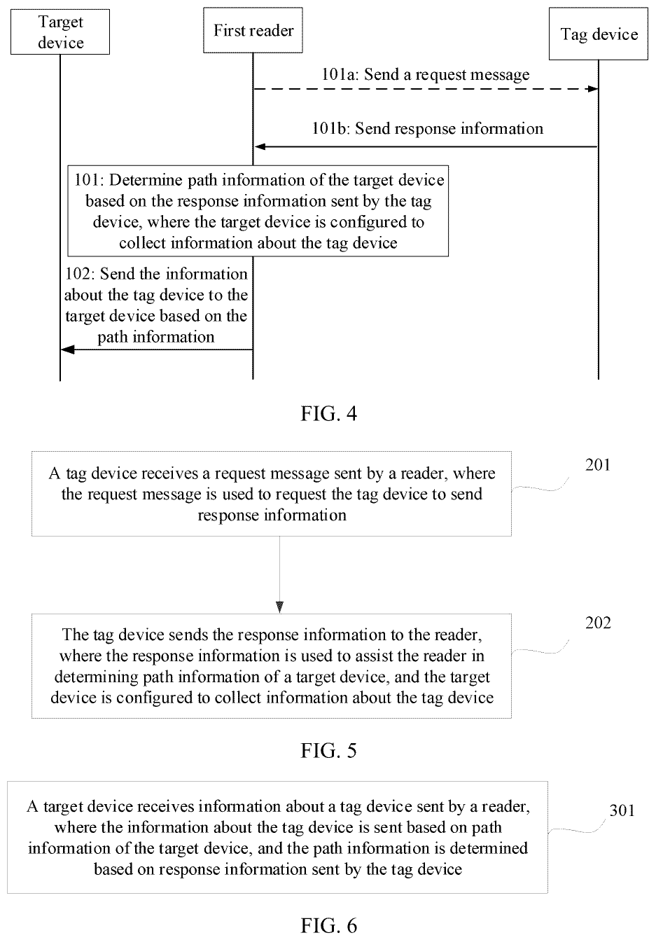

The information interaction apparatus provided in this embodiment of this application can implement the processes implemented in the method embodiment of FIG. 3 to FIG. 6, and achieve a same technical effect. To avoid repetition, details are not described herein again.

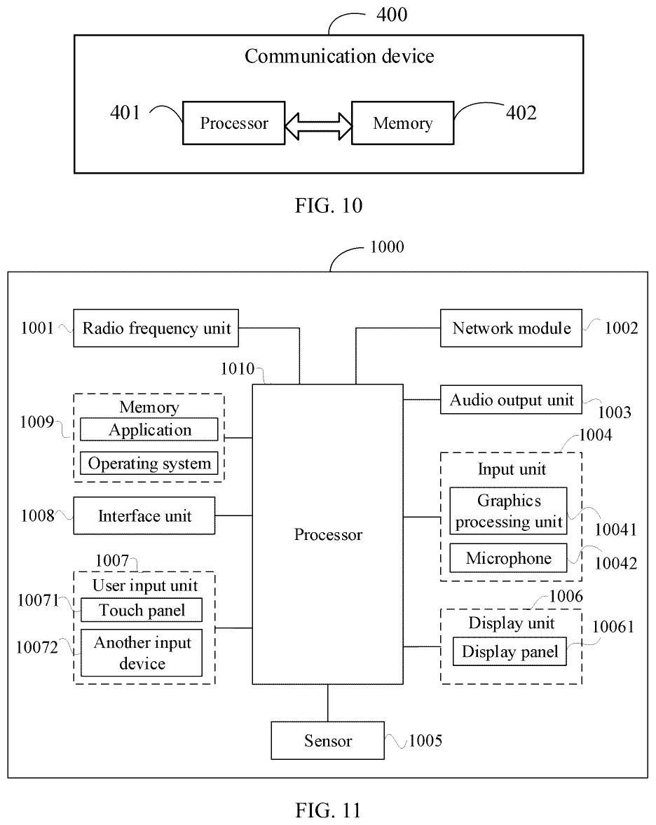

Optionally, as shown in FIG. 10, an embodiment of this application further provides a communication device 400, including a processor 401 and a memory 402. The memory 402 stores a program or an instruction that is executable on the processor 401. For example, when the communication device 400 is a reader, the program or the instruction is executed by the processor 401 to implement the steps of the foregoing embodiment of the information interaction method, and a same technical effect can be achieved. When the communication device 400 is a tag device, the program or the instruction is executed by the processor 401 to implement the steps of the foregoing embodiment of the information interaction method, and a same technical effect can be achieved. When the communication device 400 is a target device, the program or the instruction is executed by the processor 401 to implement the steps of the foregoing embodiment of the information interaction method, and a same technical effect can be achieved. To avoid repetition, details are not described herein again.

An embodiment of this application further provides a reader, including a processor and a communication interface. The processor is configured to determine path information of a target device based on response information sent by a tag device, where the target device is configured to collect information about the tag device. The communication interface is configured to send the information about the tag device to the target device based on the path information. The reader embodiment corresponds to the reader side method embodiment, each implementation process and implementation of the method embodiment can be applied to the reader embodiment, and a same technical effect can be achieved. The reader may be a terminal. Specifically, FIG. 11 is a schematic diagram of a hardware structure of a terminal according to an embodiment of this application.

The terminal 1000 includes but is not limited to at least some components in a radio frequency unit 1001, a network module 1002, an audio output unit 1003, an input unit 1004, a sensor 1005, a display unit 1006, a user input unit 1007, an interface unit 1008, a memory 1009, and a processor 1010.

A person skilled in the art can understand that the terminal 1000 may further include a power supply (such as a battery) that supplies power to each component. The power supply may be logically connected to the processor 1010 by using a power supply management system, to implement functions such as charging and discharging management, and power consumption management by using the power supply management system. The terminal structure shown in FIG. 11 constitutes no limitation on the terminal, and the terminal may include more or fewer components than those shown in the figure, or combine some components, or have different component arrangements. Details are not described herein.

It should be understood that in this embodiment of this application, the input unit 1004 may include a Graphics Processing Unit (GPU) 10041 and a microphone 10042. The graphics processing unit 10041 processes image data of a static picture or a video obtained by an image capture apparatus (for example, a camera) in a video capture mode or an image capture mode. The display unit 1006 may include a display panel 10061, and the display panel 10061 may be configured in a form of a liquid crystal display, an organic light-emitting diode, or the like. The user input unit 1007 includes at least one of a touch panel 10071 or another input device 10072. The touch panel 10071 is also referred to as a touchscreen. The touch panel 10071 may include two parts: a touch detection apparatus and a touch controller. The another input device 10072 may include, but is not limited to, a physical keyboard, a function key (such as a volume control key or an on/off key), a trackball, a mouse, and a joystick. Details are not described herein again.

In this embodiment of this application, the radio frequency unit 1001 receives downlink data from a network side device and then sends the downlink data to the processor 1010 for processing; and the radio frequency unit 1001 may send uplink data to the network side device. Usually, the radio frequency unit 1001 includes but is not limited to an antenna, at least one amplifier, a transceiver, a coupler, a low noise amplifier, a duplexer, and the like.

The memory 1009 may be configured to store a software program or an instruction and various data. The memory 1009 may mainly include a first storage area for storing a program or an instruction and a second storage area for storing data. The first storage area may store an operating system, and an application or an instruction required by at least one function (for example, a sound playing function or an image playing function). In addition, the memory 1009 may be a volatile memory or a non-volatile memory, or the memory 1009 may include both a transitory memory and a non-transitory memory. The non-volatile memory may be a Read-Only Memory (ROM), a Programmable Read-Only Memory (Programmable ROM, PROM), an Erasable Programmable Read-Only Memory (Erasable PROM, EPROM), an Electrically Erasable Programmable Read-Only Memory (Electrically EPROM, EEPROM), or a flash memory. The volatile memory may be a Random Access Memory (RAM), a Static Random Access Memory (Static RAM, SRAM), a Dynamic Random Access Memory (Dynamic RAM, DRAM), a Synchronous Dynamic Random Access Memory (Synchronous DRAM, SDRAM), a Double Data Rate Synchronous Dynamic Random Access Memory (Double Data Rate SDRAM, DDRSDRAM), an enhanced Synchronous Dynamic Random Access Memory (Enhanced SDRAM, ESDRAM), a Synch Link Dynamic Random Access Memory (Synch Link DRAM, SLDRAM), and a Direct Rambus Random Access Memory (Direct Rambus RAM, DRRAM). The memory 1009 in this embodiment of this application includes but is not limited to these memories and any memory of another proper type.

The processor 1010 may include one or more processing units. Optionally, an application processor and a modem processor may be integrated into the processor 1010. The application processor mainly processes an operating system, a user interface, an application or instruction, or the like. The modem processor mainly processes a wireless communication signal, for example, a baseband processor. It may be understood that, alternatively, the modem processor may not be integrated into the processor 1010.

The processor 1010 is configured to determine path information of a target device based on response information sent by a tag device, where the target device is configured to collect information about the tag device.

The radio frequency unit 1001 is configured to send the information about the tag device to the target device based on the path information.

Optionally, the radio frequency unit 1001 is further configured to receive configuration information sent by a network side device, where the configuration information includes at least one of the following: a correspondence between a type of tag data and an identifier of the target device, a correspondence between an identifier of the tag device and an identifier of the target device, or a correspondence between an area to which the tag device belongs and an identifier of the target device; and the identifier of the target device includes at least one of the following: a name of the target device, an ID of the target device, or an Internet Protocol IP address of the target device.

The processor 1010 is specifically configured to:
determine the path information of the target device based on the configuration information and the response information.

Optionally, the response information includes at least one of the following: an identifier ID of the tag device, tag data, a type of the tag data, or information about an area to which the tag device belongs.

Optionally, the information about the area to which the tag device belongs includes at least one of the following:
cell identification information, a cell list, base station information, a tracking area, a radio access network notification area RNA, or a public land mobile network PLMN.

Optionally, the response information includes an identifier of the target device, or includes an identifier of the target device and first information, the first information includes at least one of the following: an identifier ID of the tag device or tag data, and the identifier of the target device includes at least one of the following: a name of the target device, an ID of the target device, or an IP address of the target device.

Optionally, the identifier of the target device is configured by the network side device, or is preconfigured by the tag device.

Optionally, the identifier of the target device and the first information are carried in different signaling.

Optionally, the identifier of the target device and the first information are carried in same signaling.

Optionally, the radio frequency unit 1001 is further configured to:
send a first request to the tag device, where the first request is used to request the tag device to send the response information.

Optionally, the radio frequency unit 1001 is specifically configured to:
send the first information to the target device based on the path information.

The terminal in this embodiment may be configured to perform the information interaction method in the embodiment on the reader side. A specific implementation process and technical effects of the apparatus are similar to those in the method embodiment on the reader side. For details, refer to the detailed descriptions in the method embodiment on the reader side. Details are not described herein again.

Optionally, an embodiment of this application further provides a tag device, including a processor and a communication interface. The communication interface is configured to receive a request message sent by a reader, where the request message is used to request the tag device to send response information; and send the response information to the reader, where the response information is used to assist the reader in determining path information of a target device, and the target device is configured to collect information about the tag device. The tag device embodiment corresponds to the foregoing method embodiment on the tag device side. Each implementation process and implementation of the foregoing method embodiment are applicable to the tag device embodiment, and a same technical effect can be achieved. The tag device may alternatively be the terminal in the embodiment shown in FIG. 11.

An embodiment of this application further provides a target device. The target device may be a network side device. The target device includes a processor and a communication interface. The communication interface receives information about a tag device sent by a reader, where the information about the tag device is sent based on path information of the target device, and the path information is determined based on response information sent by the tag device. The target device embodiment corresponds to the foregoing method embodiment of the target device. Each implementation process and implementation of the foregoing method embodiment are applicable to the target device embodiment, and a same technical effect can be achieved.

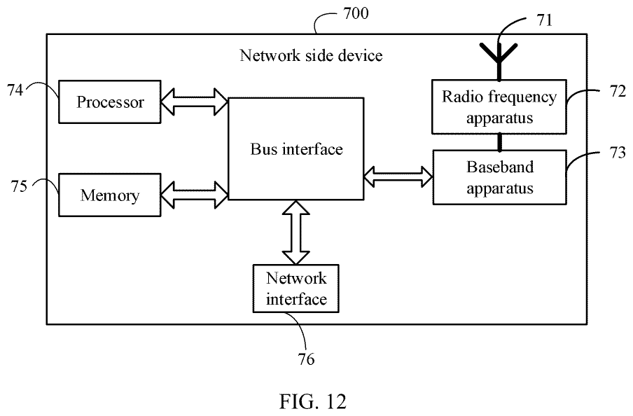

Specifically, an embodiment of this application further provides a network side device. As shown in FIG. 12, the network side device 700 includes an antenna 71, a radio frequency apparatus 72, a baseband apparatus 73, a processor 74, and a memory 75. The antenna 71 is connected to the radio frequency apparatus 72. In an uplink direction, the radio frequency apparatus 72 receives information through the antenna 71, and sends the received information to the baseband apparatus 73 for processing. In a downlink direction, the baseband apparatus 73 processes information that needs to be sent, and sends processed information to the radio frequency apparatus 72. The radio frequency apparatus 72 processes the received information, and sends processed information through the antenna 71.

The foregoing band processing apparatus may be located in the baseband apparatus 73. In the foregoing embodiment, a method performed by the network side device may be implemented in the baseband apparatus 73. The baseband apparatus 73 includes a baseband processor and a memory.

The baseband apparatus 73 may include, for example, at least one baseband board. A plurality of chips are disposed on the baseband board. As shown in FIG. 12, one chip is, for example, the baseband processor, connected to the memory through a bus interface, to invoke a program in the memory, thereby performing operations of the network device shown in the foregoing method embodiment.

The baseband apparatus 73 may further include a network interface, configured to exchange information with the radio frequency apparatus 72. For example, the interface is a Common Public Radio Interface (CPRI).

Specifically, the network side device 700 in this embodiment of the present invention further includes an instruction or a program stored in the memory 75 and executable on the processor 75. The processor 75 invokes the instruction or the program in the memory 75 to perform the method performed by the modules shown in FIG. 7 or FIG. 9, with the same technical effect achieved. To avoid repetition, details are not described herein again.

Optionally, the network side device in this embodiment may alternatively be a reader. In a case that the network side device is the reader, the network side device in this embodiment may perform the information interaction method in the reader side embodiment. A specific implementation process and technical effects of the network side device are similar to those in the method embodiment on the reader side. For details, refer to the detailed descriptions in the method embodiment on the reader side. Details are not described herein again.

An embodiment of this application further provides a readable storage medium. The readable storage medium stores a program or an instruction, and the program or the instruction is executed by a processor to implement the processes in the foregoing information interaction method embodiment, and a same technical effect can be achieved. To avoid repetition, details are not described herein again.

The processor is a processor in the terminal in the foregoing embodiments. The readable storage medium includes a computer-readable storage medium, such as a computer read-only memory ROM, a random access memory RAM, a magnetic disk, or an optical disc.

An embodiment of this application further provides a chip. The chip includes a processor and a communication interface, the communication interface is coupled to the processor, and the processor is configured to run a program or an instruction to implement the processes of the foregoing information interaction method embodiment, and a same technical effect can be achieved. To avoid repetition, details are not described herein again.

It should be understood that the chip mentioned in this embodiment of this application may also be referred to as a system-level chip, a system chip, a chip system, or a system on chip.

An embodiment of this application further provides a computer program/program product. The computer program/program product is stored in a storage medium, and the program/program product is executed by at least one processor to implement the processes of the foregoing information interaction method embodiment, and a same technical effect can be achieved. To avoid repetition, details are not described herein again.

An embodiment of this application further provides a communication system, including a reader, a tag device, and a target device. The reader may be configured to perform the steps of the information interaction method described above, the tag device may be configured to perform the steps of the information interaction method described above, and the target device may be configured to perform the steps of the information interaction method described above.

It should be noted that, in this specification, the term “include”, “comprise”, or any other variant thereof is intended to cover a non-exclusive inclusion, so that a process, a method, an article, or an apparatus that includes a list of elements not only includes those elements but also includes other elements which are not expressly listed, or further includes elements inherent to this process, method, article, or apparatus. In absence of more constraints, an element preceded by “includes a . . . ” does not preclude the existence of other identical elements in the process, method, article, or apparatus that includes the element. In addition, it should be noted that the scope of the methods and apparatuses in the embodiments of this application is not limited to performing functions in the order shown or discussed, but may also include performing the functions in a basically simultaneous manner or in opposite order based on the functions involved. For example, the described methods may be performed in a different order from the described order, and various steps may be added, omitted, or combined. In addition, features described with reference to some examples may be combined in other examples.

Based on the descriptions of the foregoing implementations, a person skilled in the art may clearly understand that the method in the foregoing embodiment may be implemented by software in addition to a necessary universal hardware platform or by hardware only. In most circumstances, the former is a preferred implementation. Based on such an understanding, the technical solutions of this application essentially or the part contributing to the prior art may be implemented in a form of a computer software product. The computer software product is stored in a storage medium (for example, a ROM/RAM, a floppy disk, or an optical disc), and includes several instructions for instructing a terminal (which may be a mobile phone, a computer, a server, an air conditioner, a network device, or the like) to perform the methods described in the embodiments of this application.

The embodiments of this application are described above with reference to the accompanying drawings, but this application is not limited to the foregoing specific implementations, and the foregoing specific implementations are only illustrative and not restrictive. Under the enlightenment of this application, a person of ordinary skill in the art can make many forms without departing from the purpose of this application and the protection scope of the claims, all of which fall within the protection of this application.

1. An information interaction method, comprising:
determining, by a reader, path information of a target device based on response information sent by a tag device, wherein the target device is configured to collect information about the tag device; and
sending, by the reader, the information about the tag device to the target device based on the path information.

2. The information interaction method according to claim 1, wherein the method further comprises:
receiving, by the reader, configuration information sent by a network side device, wherein the configuration information comprises at least one of the following: a correspondence between a type of tag data and an identifier of the target device, a correspondence between an identifier of the tag device and an identifier of the target device, or a correspondence between an area to which the tag device belongs and an identifier of the target device; and the identifier of the target device comprises at least one of the following: a name of the target device, an ID of the target device, or an Internet Protocol IP address of the target device; and
the determining, by a reader, path information of a target device based on response information comprises:
determining, by the reader, the path information of the target device based on the configuration information and the response information.

3. The information interaction method according to claim 2, wherein the response information comprises at least one of the following: an identifier (ID) of the tag device, tag data, a type of the tag data, or information about the area to which the tag device belongs.

4. The information interaction method according to claim 3, wherein the information about the area to which the tag device belongs comprises at least one of the following:
cell identification information, a cell list, base station information, a tracking area, a radio access network notification area RNA, or a public land mobile network (PLMN) ID.

5. The information interaction method according to claim 1, wherein the response information comprises an identifier of the target device, or comprises an identifier of the target device and first information, the first information comprises at least one of the following: an identifier ID of the tag device or tag data, and the identifier of the target device comprises at least one of the following: a name of the target device, an ID of the target device, or an IP address of the target device.

6. The information interaction method according to claim 5, wherein the identifier of the target device is configured by a network side device, or is preconfigured by the tag device.

7. The information interaction method according to claim 5, wherein
the identifier of the target device and the first information are carried in different signaling.

8. The information interaction method according to claim 5, wherein
the identifier of the target device and the first information are carried in same signaling.

9. The information interaction method according to claim 5, wherein before the reader obtains the response information sent by the tag device, the method further comprises:
sending, by the reader, a first request to the tag device, wherein the first request is used to request the tag device to send the response information; and
the sending, by the reader, the information about the tag device to the target device based on the path information comprises:
sending, by the reader, the first information to the target device based on the path information.

10. An information interaction method, comprising:
receiving, by a tag device, a request message sent by a reader, wherein the request message is used to request the tag device to send response information; and
sending, by the tag device, the response information to the reader, wherein the response information is used to assist the reader in determining path information of a target device, and the target device is configured to collect information about the tag device.

11. The information interaction method according to claim 10, wherein the response information comprises at least one of the following: an identifier (ID) of the tag device, tag data, a type of the tag data, or information about an area to which the tag device belongs.

12. The information interaction method according to claim 11, wherein the information about the area to which the tag device belongs comprises at least one of the following:
cell identification information, a cell list, base station information, a tracking area, a radio access network notification area (RNA), or a public land mobile network (PLMN).

13. The information interaction method according to claim 10, wherein the response information comprises an identifier of the target device, or comprises an identifier of the target device and first information, the first information comprises at least one of the following: an identifier (ID) of the tag device or tag data, and the identifier of the target device comprises at least one of the following: a name of the target device, an ID of the target device, or an IP address of the target device.

14. The information interaction method according to claim 13, wherein the method further comprises:
receiving, by the tag device, the identifier of the target device sent by a network side device.

15. The information interaction method according to claim 13, wherein
the identifier of the target device is preconfigured by the tag device.

16. The information interaction method according to claim 13, wherein
the identifier of the target device and the first information are carried in different signaling.

17. The information interaction method according to claim 13, wherein
the identifier of the target device and the first information are carried in same signaling.

18. An information interaction device, comprising a processor and a memory, wherein the memory stores a program or an instruction that is executable on the processor, and the program or the instruction is configured to be executed by the processor to implement an information interaction method, the method comprising:
determining path information of a target device based on response information sent by a tag device, wherein the target device is configured to collect information about the tag device; and
sending the information about the tag device to the target device based on the path information.

19. The information interaction device according to claim 18, wherein the method implemented by the program or the instruction further comprises:
receiving configuration information sent by a network side device, wherein the configuration information comprises at least one of the following: a correspondence between a type of tag data and an identifier of the target device, a correspondence between an identifier of the tag device and an identifier of the target device, or a correspondence between an area to which the tag device belongs and an identifier of the target device; and the identifier of the target device comprises at least one of the following: a name of the target device, an ID of the target device, or an Internet Protocol IP address of the target device; and
the determining path information of a target device based on response information comprises:
determining the path information of the target device based on the configuration information and the response information.

20. The information interaction device according to claim 19, wherein the response information comprises at least one of the following: an identifier (ID) of the tag device, tag data, a type of the tag data, or information about the area to which the tag device belongs.
